(19) United States
(12) Patent Application Publication
(10) Pub. No.: US 2014/0159915 A1
(43) Pub. Date: Jun. 12, 2014

(54) APPARATUS AND METHOD FOR COMPREHENSIVELY MONITORING SLOPES BASED ON WIRELESS NETWORK

(71) Applicant: Electronics and Telecommunications Research Institute, Daejeon-si (KR)

(72) Inventors: Sang-Gi HONG, Daejeon-si (KR); Young-Bag MOON, Daejeon-si (KR); Nae-Soo KIM, Daejeon-si (KR)

(73) Assignee: Electronics and Telecommunications Research Institute, Daejeon-si (KR)

(21) Appl. No.: 13/973,279

(22) Filed: Aug. 22, 2013

(30) Foreign Application Priority Data
Dec. 12, 2012 (KR) 10-2012-0144636

(51) Int. Cl. G08C 17/02

(52) U.S. Cl. CPC G08C 17/02
USPC 340/870.07

(57) ABSTRACT

A method of comprehensively monitoring slopes based on a wireless network in a sensor node is provided. The method includes acquiring sensing data of first sensing frequencies for determining a risk to the slopes, transmitting the acquired sensing data of first sensing frequencies to an analysis server through a gateway, acquiring sensing data of second sensing frequencies for determining the risk to the slopes when operation mode received from the analysis server through the gateway is precision mode, and transmitting the acquired sensing data of second sensing frequencies to the analysis server through the gateway.

### CROSS-REFERENCE TO RELATED APPLICATION

This application claims priority from Korean Patent Application No. 10-2012-0144636, filed on Dec. 12, 2012, in the Korean Intellectual Property Office, the entire disclosure of which is incorporated herein by reference for all purposes.

### BACKGROUND

1. Field

The following description relates to an apparatus and method of comprehensively monitoring mountain slopes, and more specifically, to an apparatus and method of comprehensively monitoring slopes based on a wireless network.

2. Description of the Related Art

In recent years, a landslide occurrence frequency has increased due to the localized heavy rain caused by abnormal changes in weather, and the scale of damage has been larger due to construction of a large-scale cut slope, new construction of apartment housings near a steep slope-land, and the like. Therefore, studies on a method of reinforcing various slopes and an early warning system for landslide have been actively made in order to ensure the safety of the slope.

In addition, since occurrence of the rockfall in roadside cutting areas may lead to big accidents because vehicles are running at high speed on the highways or the national roads, there are urgent demands for a rockfall prevention method and an early warning system for rockfall.

In response to these demands, an early warning system for landslide which has been developed may capture collapse signs prior to the occurrence of landslide or the moment of the occurrence of landslide, and then promptly transmit the captured information to neighboring residents or managers in landslide occurrence places, so that the neighboring residents may be safely evacuated from danger slopes of the landslide occurrence place, or emergency restoration for the slopes may be made possible.

Here, rapidly and accurately predicting the occurrence of landslide can be called the core of the early warning system for landslide.

In technologies for early warning for landslide or rockfall according to the prior art, a variety of measurement sensors capable of measuring small movements of the slope such as displacement, slope, depression of the ground, and the like, for example, an underground inclinometer, a settlement measuring device, a ground surface extensometer, a crack measuring device, and the like are installed in the slope to perform measurement, and danger signals are sent when the measurement data exceeds a preset threshold value.

For this, in the measurement sensors, a power cable for supplying electric power and a communication cable for transmitting measurement data to a data logger should be connected with each other.

In such technologies for early warning for landslide according to the prior art, high installation costs of a measurement device and skilled workers are required because a hole with a deep depth has to be drilled in the ground when installing the measurement device, and therefore there is a problem that the measurement sensors are difficult to be extensively and highly densely installed.

In addition, power has to be supplied to the measurement sensors for detecting landslides, and the measurement sensors have to be connected to the communication cable. However, such a cable wiring processing work is difficult in the steep slope, and separate communication and power supply apparatuses have to be installed in mountainous areas in which communication and electric power infrastructures are not equipped.

Due to problems of a wired network-based system as described above, systems for wirelessly monitoring the landslide or the slope using a wireless sensor network have been recently developed.

In such a monitoring system using the wireless sensor network, a sensor in which a short-range wireless module is mounted provides sensing data through a wireless sensor network (802.15.4).

However, in a case of the sensing data using the wireless sensor network (802.15.4), only basic information for monitoring collapse of the slope is provided due to the limit of data transfer speed, whereby accurate monitoring cannot be performed.

### SUMMARY

The following description relates to an apparatus and method of comprehensively monitoring slopes based on a wireless network which determines whether precision analysis of the mountain slopes is required from sensing data acquired from a sensor of first sensing frequencies, and performs the precision analysis by driving a sensor of second sensing frequencies.

The following description also relates to an apparatus and method of comprehensively monitoring slopes based on a wireless network which copes with emergency situations by transmitting sensor data required for precision analysis in real-time through a high-speed communication.

In one general aspect, a method of comprehensively monitoring slopes based on a wireless network in a sensor node, includes: acquiring sensing data of first sensing frequencies for determining a risk to the slopes; transmitting the acquired sensing data of first sensing frequencies to an analysis server through a gateway; acquiring sensing data of second sensing frequencies for determining the risk to the slopes when operation mode received from the analysis server through the gateway is precision mode; and transmitting the acquired sensing data of second sensing frequencies to the analysis server through the gateway.

In another general aspect, a method of monitoring slopes based on a wireless network in an analysis server, includes: analyzing sensing data transmitted from at least one sensor node; determining a risk to the slopes in accordance with the analysis result; deciding an operation mode of the sensor node in accordance with the determination result; and transmitting the decided operation mode to the sensor node through a gateway.

In still another general aspect, a sensor node includes: a wireless communication unit; at least one low sampling sensor configured to acquire sensing data for determining a risk to a slope with first sensing frequencies; at least one high sampling sensor configured to acquire sensing data for determining the risk to the slopes with second sensing frequencies; and a control unit configured to transmit the sensing data of the at least one low sampling sensor to an analysis server through the wireless communication unit, acquire the sensing data from all of the at least one low sampling sensor and the at least one high sampling sensor when operation mode transmitted from the analysis server is precision mode, and control the acquired sensing data to be transmitted to the analysis server.

In yet another general aspect, an analysis server includes: a communication unit; a data analysis unit configured to analyze sensing data transmitted from at least one sensor node; an operation mode deciding unit configured to determine presence or absence of a risk to a slope in accordance with the analysis result and decide an operation mode of the sensor node; and an operation mode transmitting unit configured to transmit the decided operation mode to the sensor node through a gateway.

Other features and aspects will be apparent from the following detailed description, the drawings, and the claims.

### BRIEF DESCRIPTION OF THE DRAWINGS

FIG. 1 is a schematic configuration diagram illustrating a system of monitoring slopes based on a wireless network according to an embodiment of the present invention;

FIG. 2 is a configuration diagram illustrating a sensor node according to an embodiment of the present invention;

FIG. 3 is a configuration diagram illustrating a sensor node according to another embodiment of the present invention;

FIG. 4 is a configuration diagram illustrating a gateway according to an embodiment of the present invention;

FIG. 5 is a configuration diagram illustrating an analysis server according to an embodiment of the present invention; and

FIG. 6 is a flowchart illustrating a method of monitoring slopes based on a wireless network according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

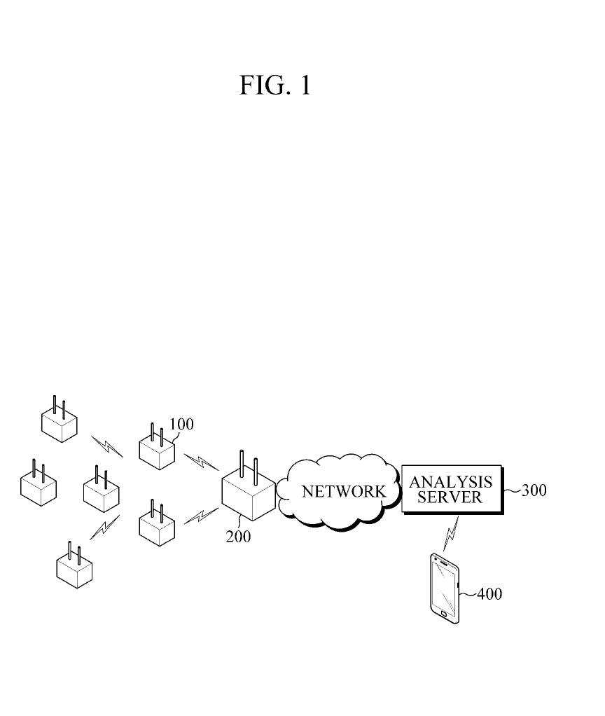

FIG. 1 is a schematic configuration diagram illustrating a system of comprehensively monitoring slopes based on a wireless network according to an embodiment of the present invention.

Referring to FIG. 1, the system of monitoring the slopes based on the wireless network according to an embodiment of the present invention includes at least one sensor nodes 100, a gateway 200, and an analysis server 300.

The system shown in FIG. 1 comprehensively monitors slopes and notifies a possibility of occurrence of a disaster such as landslide or rockfall which may occur in various slopes including uneven slopes of the ground, mountain slopes, a roadside cutting area, steep slopes in which buildings are newly constructed, and the like.

The sensor nodes 100 may be installed on a slope having a risk of landslide or rockfall, and a wireless multi-hop ad hoc network between the sensor nodes 100 may be formed.

Thus, the sensor nodes 100 may jointly perform router function, and be able to configure a network themselves. Accordingly, when a communication failure occurs in any one of the sensor nodes 100, it is possible to prevent communication from being interrupted by providing a bypass route.

The sensor nodes 100 detect the ground conditions associated with landslide or rockfall of the ground to be measured at prescribed time intervals so as to obtain sensing data, and wirelessly transmit the obtained sensing data to the gateway 200.

The gateway 200 wirelessly receives the sensing data from the sensor nodes 100, and transmits the received sensing data to the analysis server 300 through a wired or wireless communication network.

The analysis server 300 analyzes the sensing data transmitted from the sensor nodes 100 through the gateway 200, and retransmits the analysis result to the sensor nodes 100 through the gateway 200. That is, the analysis server 300 receives ground condition information from the sensor nodes 100, determines whether landslide or rockfall is likely to occur based on the ground condition information, and decides an operation mode in accordance with the determination result.

Here, the operation mode according to an embodiment of the present invention refers to a method of operating the sensor nodes 100, and may include a normal mode and a precision mode.

In the normal mode, the sensor node 100 may be operated with first sensing frequencies in an initialization operation of the sensor nodes 100 or a state in which a possibility of occurrence of a risk is small. In the precision mode, based on the analysis result of the sensing data analyzed by the analysis server 300, the sensor nodes 100 may be operated with second sensing frequencies in a state in which the possibility of occurrence of the risk is large.

Here, the first sensing frequencies may refer to sensing frequencies less than a predetermined threshold value, and the second sensing frequencies may refer to sensing frequencies larger than the predetermined threshold value.

When it is determined that landslide or rockfall is likely to occur, a precision mode control signal for increasing the sensing frequencies to more carefully monitor conditions of the ground to be measured may be transmitted to the sensor nodes 100.

The analysis server 300 stores the received measurement data, compares and analyzes data about a correlation between the rainfall of the ground to be measured and a safety factor of the slope, a correlation between an acceleration and presence or absence of the occurrence of landslide, a correlation between a shearing resistance force of skin friction of the ground to be measured and the safety factor of the slope, and the like, which are stored in advance in a database, and the measurement values of the ground to be measured, and then determines the safety factor of the slope based on the comparison and analysis result.

Meanwhile, when it is determined that landslide or rockfall is likely to occur, the analysis server 300 generates an alarm signal for notifying a risk of the occurrence of the landslide or rockfall. That is, an alarm (not shown) sounds a warning sound or an alarm signal is transmitted to a user terminal 400 through a communication network so that a user may recognize risks of landslide and rockfall.

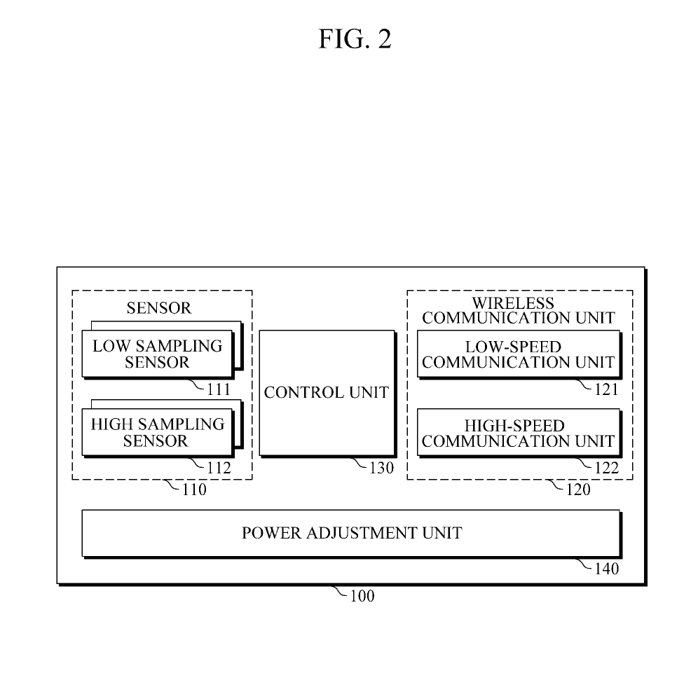

FIG. 2 is a configuration diagram illustrating a sensor node according to an embodiment of the present invention.

Referring to FIG. 2, the sensor node according to an embodiment of the present invention includes a sensor 110, a wireless communication unit 120, and a control unit 130. The sensor node further includes a power adjustment unit 140.

The sensor 110 detects ground condition information associated with landslide and rockfall such as displacement, slope, subsidence, rainfall, and the like at prescribed time intervals or in real-time, and transmits the detected ground condition information to the control unit 130.

According to an embodiment of the present invention, the sensor 110 includes a low sampling sensor 111 and a high sampling sensor 112.

The low sampling sensor 111 acquires sensing data for determining a risk to a slope with first sensing frequencies. For example, the low sampling sensor 111 is a sensor for measuring a physical amount which is slowly changed in accordance with changes in time and environments, and includes a soil moisture measurement sensor, a tilt measurement sensor, a soil temperature measurement sensor, a debris flow analysis sensor, and a flow rate detection sensor.

The sensing data acquired by the low sampling sensor 111 may be used as initial information for determining a risk to the slopes.

The high sampling sensor 112 acquires sensing data for determining a risk to a slope with second sensing frequencies. For example, the high sampling sensor 112 is a sensor for measuring a physical amount which is rapidly changed, and includes a vibration sensor for detecting vibration of the ground surface, an acoustic sensor for detecting underground water flowing noise, and an acoustic sensor for detecting plosive sounds due to forest soil sediment disaster.

The sensing data acquired by the high sampling sensor 112 may be used to accurately determine the risk to the slopes the when a control signal for allowing an operation in a precision mode is received from the analysis server 300.

The wireless communication unit 120 allows the sensing data input from the control unit 130 to be transmitted to the analysis server 300 through the gateway 200.

According to an embodiment of the present invention, the wireless communication unit 120 includes a low-speed communication unit 121 and a high-speed communication unit 122.

The low-speed communication unit 121 transmits the sensing data to the gateway 200 through multi-hop communication in a low-power short-range wireless network such as 802.15.4at a lower speed than a predetermined threshold value. According to an embodiment of the present invention, the sensing data output from the low sampling sensor 111 is transmitted through the low-speed communication unit 121.

The high-speed communication unit 122 directly transmits the sensing data at a higher speed than a prescribed threshold value to the analysis server 300, such as 3G, LTE, or the like, or transmits the sensing data at a higher speed than a predetermined threshold value by performing multi-hop communication (mesh network) in a high-speed short-range wireless network such as 802.11.s. According to an embodiment of the present invention, a large amount of sensing data is transmitted from the high sampling sensor 112 through the high-speed communication unit 122 in real-time.

The control unit 130 acquires and transmits the sensing data, and generally controls the sensor node. Specifically, the control unit 130 transmits the sensing data acquired by the low sampling sensors 111 to the analysis server 300 through the low-speed communication unit 121, acquires sensing data from all of the low sampling sensors 111 and the high sampling sensors 112 in real-time when operation mode requested from the analysis server 300 is precision mode, and controls the acquired sensing data to be transmitted to the analysis server 300 through the high-speed communication unit 122.

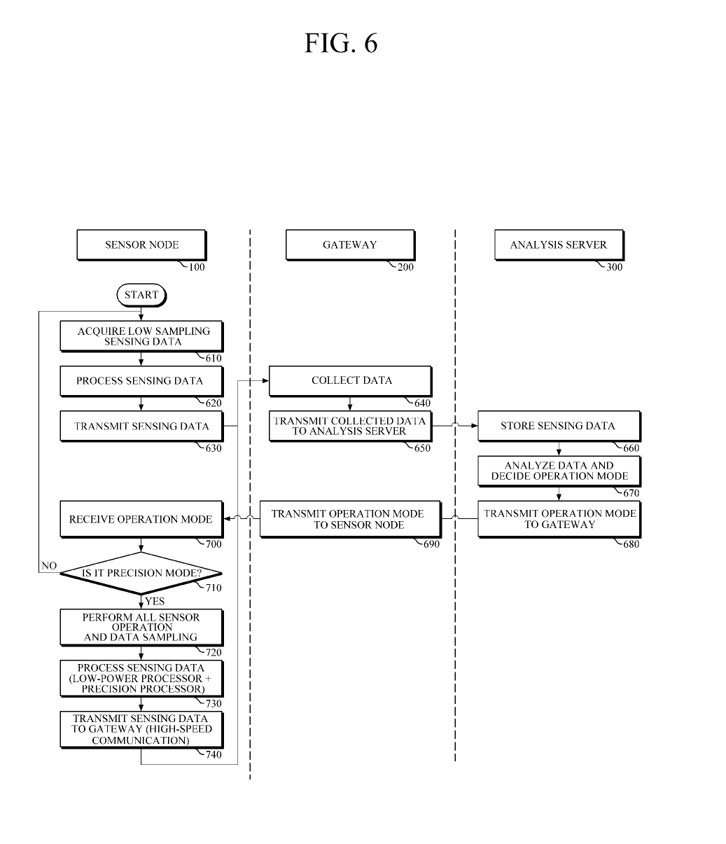

Detailed operations of the control unit 130 will be described in detail with reference to FIG. 6.

The power adjustment unit 140 supplies power to the sensor 110, the wireless communication unit 120, and the control unit 130, and desirably facilitates an installation operation of the sensor node 100 using a battery not requiring a cable for power supply, a solar battery, or the like.

According to an embodiment of the present invention, the power adjustment unit 140 changes power operation in accordance with an operation mode to reduce the amount of discharge, so that power may be able to be used for an extended period of time.

That is, power less than a predetermined threshold value may be applied to the low sampling sensor 111 and the low-speed communication unit 121, and power larger than the predetermined threshold value may be applied to the high sampling sensor 112 and the high-speed communication unit 122.

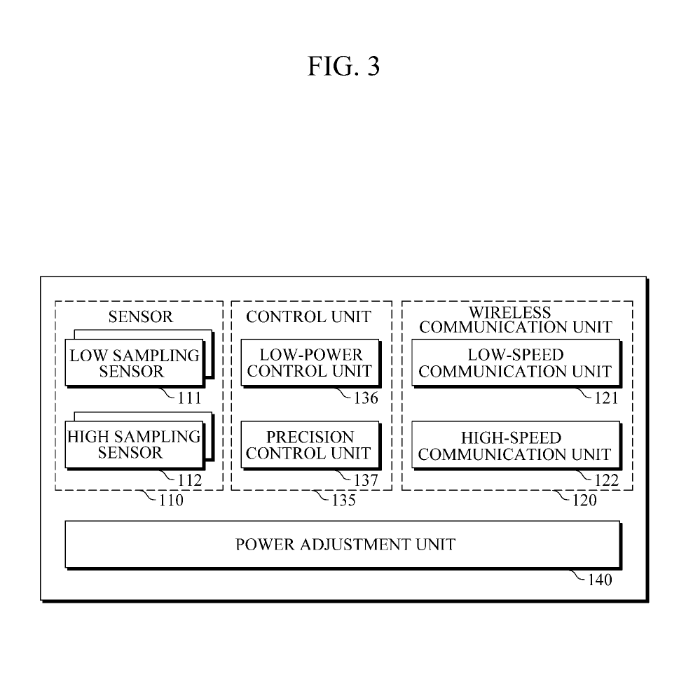

FIG. 3 is a configuration diagram illustrating a sensor node according to another embodiment of the present invention.

Referring to FIG. 3, a configuration of the sensor node according to another embodiment of the present invention is the same as that of the sensor node described in FIG. 2 except the control unit 135, and thus only the control unit 135 will be described.

According to another embodiment of the present invention, the control unit 135 includes a low-power control unit 136 and a precision control unit 137.

The low-power control unit 136 acquires sensing data from the low sampling sensor 110, and transmits the acquired sensing data to the gateway 200 through the low-speed communication unit 121. The low-power control unit 136 drives the precision control unit 137 when receiving control information for allowing an operation of a precision mode through the low-speed communication unit 121 from the gateway 200.

Next, the precision control unit 137 acquires sensing data from the high sampling sensor 112, and determines presence or absence of a risk by performing precision analysis such as direct frequency analysis and the like.

Therefore, a precision analysis operation in the analysis server 300 is omitted, and an amount of data to be transmitted from the sensor node 100 to the analysis server 300 may be reduced.

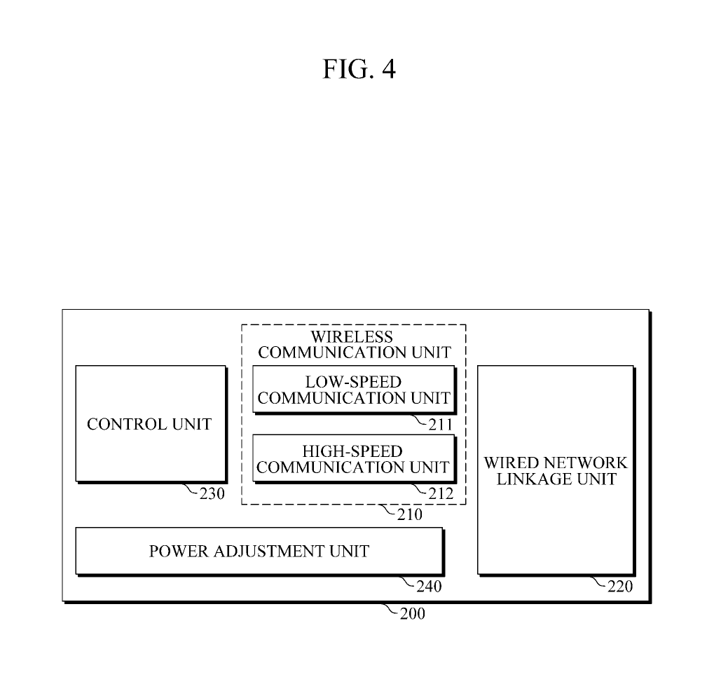

FIG. 4 is a configuration diagram illustrating a gateway according to an embodiment of the present invention.

Referring to FIG. 4, the gateway 200 includes a wireless communication unit 210, a wired network linkage unit 220, and a control unit 230. The gateway 200 further includes a power adjustment unit 240.

The wireless communication unit 210 receives sensing data transmitted from the sensor nodes 100, and transmits the received sensing data to the control unit 230.

According to an embodiment of the present invention, the wireless communication unit 210 includes a low-speed communication unit 211 and a high-speed communication unit 212.

The low-speed communication unit 211 receives the sensing data transmitted through the low-speed communication unit 121, through multi-hop communication in a low-power short-range wireless network such as 802.15.4 at a speed lower than a predetermined threshold value.

The high-speed communication unit 212 receives the sensing data transmitted through the high-speed communication unit 122, through multi-hop communication (mesh network) in a high-speed short-range wireless network such as 802.11.s at a speed higher than the predetermined threshold value.

The wired network linkage unit 220 is a device for a linkage with the analysis server 300 connected to a wired network, and may be WCDMA, LTE, or the like for linkage of an Ethernet module or a mobile communication network.

The control unit 230 receives and transmits sensing data, and generally controls the gateway 200. Detailed operations of the control unit 230 will be described in detail with reference to FIG. 6.

The power adjustment unit 240 supplies power to the wireless communication unit 210, the wired network linkage unit 220, and the control unit 230, and desirably facilitates an installation operation of the gateway 200 using a battery not requiring a cable for power supply, a solar battery, or the like.

According to an embodiment of the present invention, the power adjustment unit 240 changes power operation in accordance with an operation mode to reduce the amount of discharge, so that power may be able to be used for an extended period of time.

That is, power less than a predetermined threshold value may be applied to the low-speed communication unit 211, and power larger than the predetermined threshold value may be applied to the high-speed communication unit 212.

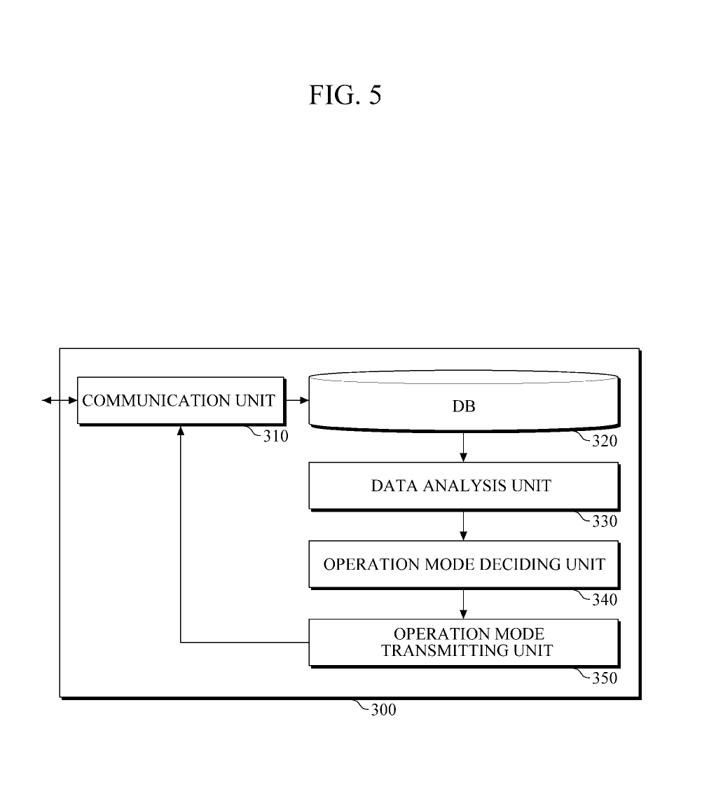

FIG. 5 is a configuration diagram illustrating an analysis server according to an embodiment of the present invention.

Referring to FIG. 5, the analysis server 300 includes a communication unit 310, a database (DB) 320, a data analysis unit 330, an operation mode deciding unit 340, and an operation mode transmitting unit 350.

The communication unit 310 receives sensing data transmitted from the gateway 200, and stores the received sensing data in the DB 320.

The communication unit 310 may be a WCDMA and LTE connection module for linkage of an Ethernet module or a mobile communication network which is connected to a wired network.

The DB 320 stores the sensing data received through the communication unit 310. In addition, the DB 320 stores preliminary information for deciding an operation mode, and includes a correlation between the rainfall of the ground to be measured and a safety factor of the slope, a correlation between an acceleration and presence or absence of the occurrence of landslide, a correlation between a shearing resistance force of skin friction of the ground to be measured and the safety factor of the slope, and the like.

The data analysis unit 330 analyzes the sensing data transmitted from the sensor nodes 100 through the gateway 200. That is, the data analysis unit 330 receives ground condition information of the ground to be measured from the sensor nodes 100, and determines whether landslide or rockfall is likely to occur based on the ground condition information.

In this instance, the data analysis unit 330 compares and analyzes data about a correlation between the rainfall of the ground to be measured and a safety factor of the slope, a correlation between an acceleration and presence or absence of the occurrence of landslide, a correlation between a shearing resistance force of skin friction of the ground to be measured and the safety factor of the slope, and the like, which are stored in advance in a database, and the measurement values of the ground to be measured, and then determines the safety factor of the slope based on the comparison and analysis result.

The operation mode deciding unit 340 compares the determined safety factor of the slope and a preset target value to determine presence or absence of a risk to a slope, and decides an operation mode of the sensor node.

That is, when it is determined as the presence of the risk to the slopes, the operation mode may be decided as a precision mode. Here, the precision mode refers to more accurately measuring ground condition information associated with landslide and rockfall by increasing sensing frequencies of the sensor node, and allows the high sampling sensor 112 to be operated.

The operation mode transmitting unit 350 transmits the decided operation mode to the gateway 200 through the communication unit 310.

Meanwhile, when the risk to the slopes is determined to be high, the analysis server 300 generates an alarm signal for notifying a risk of the occurrence of landslide and rockfall. That is, an alarm (not shown) sounds a warning sound or the alarm signal is transmitted to a user terminal through a communication network so that a user may recognize risks of landslide and rockfall.

FIG. 6 is a flowchart illustrating a method of monitoring slopes based on a wireless network according to an embodiment of the present invention.

Referring to FIG. 6, each of the sensor node 100, the gateway 200, and the analysis server 300 performs its initialization to start operation. Through the initialization, the sensor node 100, the gateway 200, and the analysis server 300 may be in a data transmission enable state through a wired and wireless network (low-power and low-speed communication, high-speed communication, wired network linkage, and the like).

In operation 610, the sensor node 100 acquires sensing data detected with first sensing frequencies. That is, the sensor node 100 acquires the sensing data using the low sampling sensor 111.

In operation 620, the sensor node 100 collect sensing data of first sensing frequencies acquired for a predetermined time period and convert the collected sensing data in the form of transmittable data.

In operation 630, the sensor node 100 transmits the sensing data to the gateway 200. In this instance, the sensing data is transmitted in a low-power low-speed wireless communication method.

Next, in operation 640, the gateway 200 collects and processes the received sensing data.

In operation 650, the gateway 200 transmits the collected and processed sensing data to the analysis server 300.

In operation 660, the analysis server 300 receives the sensing data transmitted from the gateway 200, and stores the received data in the DB 320.

Next, in operation 670, the analysis server 300 analyzes the stored sensing data, analyzes the sensing data transmitted from the sensor nodes 100 through the gateway 200, and decides an operation mode in accordance with the analysis result.

That is, the analysis server 300 receives ground condition information of the ground to be measured from the sensor node 100, and determines whether landslide or rockfall is likely to occur based on the ground condition information.

In this instance, the analysis server 300 compares and analyzes data about a correlation between the rainfall of the ground to be measured and a safety factor of the slope, a correlation between an acceleration and presence or absence of the occurrence of landslide, a correlation between a shearing resistance force of skin friction of the ground to be measured and the safety factor of the slope, and the like, which are stored in advance in a database, and the measurement values of the ground to be measured, and then determines the safety factor of the slope based on the comparison and analysis result.

In addition, the analysis server 300 compares the determined safety factor and a preset target value to determine presence or absence of a risk to the slopes, and decides an operation mode of the sensor node.

That is, when it is determined as the presence of the risk to the slopes, the operation mode is decided as a precision mode, and when it is determined as the absence of the risk to the slopes, the operation mode is decided as a normal mode.

In operation 680, the analysis server 300 transmits the decided operation mode to the gateway 200, and then, in operation 690, the gateway 200 transmits operation mode to a corresponding sensor node 100.

In operation 700, the sensor node 100 receives the operation mode.

In operation 710, the sensor node 100 determines whether the operation mode is a precision mode.

When the operation mode is the precision mode based on the determination result of operation 710, the sensor node 100 proceeds operation 610.

However, when the operation mode is not precision mode based on the determination result of operation 710, the sensor node 100 sets the operation mode as the precision mode in operation 720.

That is, in the precision mode, sensing data for all sensors is acquired, and sampling at a higher speed than a predetermined threshold value is performed with respect to the sensor requiring precision analysis.

In operation 730, the sensor node 100 processes the sensing data. In this instance, the precision control unit 137 of the sensor node 100 acquires the sensing data from the high sampling sensor 112, and performs precision analysis such as direct frequency analysis or the like to determine presence or absence of the risk to the slopes.

Therefore, a precision analysis operation in the analysis server 300 is omitted, and an amount of data to be transmitted from the sensor node 100 to the analysis server 300 may be reduced.

In operation 740, the sensor node transmits the sensing data acquired in the precision mode to the analysis server 300 through the gateway 200 at a higher speed than a predetermined threshold value.

Next, operations 640 to 690 are performed.

As described above, according to the embodiments of the present invention, compared to an existing system for monitoring landslide and slope and an existing forest soil sediment disaster system, maintenance may be facilitated, and performance of the system may be improved by data fusion between sensor nodes by applying a wireless sensor network.

In addition, a cable laying work on a danger slope when installing a measurement device may be minimized, and a monitoring network for landslide or rockfall may be easily constructed even in mountainous areas.

In addition, threshold values with respect to measurement values of the ground to be measured may be set in advance so as to adjust measurement frequencies, and therefore it is possible to prepare emergencies by intensively tightening guard against signs of landslide or rockfall.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of comprehensively monitoring slopes based on a wireless network in a sensor node, the method comprising:
acquiring sensing data of first sensing frequencies for determining a risk to the slopes;
transmitting the acquired sensing data of first sensing frequencies to an analysis server through a gateway;
acquiring sensing data of second sensing frequencies for determining the risk to the slopes when operation mode received from the analysis server through the gateway is precision mode; and
transmitting the acquired sensing data of second sensing frequencies to the analysis server through the gateway.

2. The method of claim 1, wherein the transmitting of the sensing data of first sensing frequencies includes transmitting the sensing data of first sensing frequencies using power less than a predetermined threshold value and communication at a speed lower than a predetermined threshold value.

3. The method of claim 1, wherein the transmitting of the sensing data of second sensing frequencies includes transmitting the sensing data of second sensing frequencies using communication at a speed higher than a predetermined threshold value.

4. The method of claim 1, further comprising:
determining presence or absence of the risk to the slopes by analyzing the sensing data of second sensing frequencies.

5. A method of comprehensively monitoring slopes based on a wireless network in an analysis server, the method comprising:
analyzing sensing data transmitted from at least one sensor node;
determining a risk to the slopes in accordance with the analysis result;
deciding an operation mode of the sensor node in accordance with the determination result; and
transmitting the decided operation mode to the sensor node through a gateway.

6. The method of claim 5, further comprising:
storing the sensing data in a database.

7. The method of claim 5, wherein the deciding of the operation mode includes deciding the operation mode as a precision mode when a safety factor of a slope is less than a predetermined threshold value.

8. A sensor node comprising:
a wireless communication unit;
at least one low sampling sensor configured to acquire sensing data for determining a risk to a slope with first sensing frequencies;
at least one high sampling sensor configured to acquire sensing data for determining the risk to the slopes with second sensing frequencies; and
a control unit configured to transmit the sensing data of the at least one low sampling sensor to an analysis server through the wireless communication unit, acquire the sensing data from all of the at least one low sampling sensor and the at least one high sampling sensor when operation mode transmitted from the analysis server is precision mode, and control the acquired sensing data to be transmitted to the analysis server.

9. The sensor node of claim 8, wherein the at least one low sampling sensor includes at least one of a soil moisture measurement sensor, a tilt measurement sensor, a soil temperature measurement sensor, a debris flow analysis sensor, and a flow rate detection sensor.

10. The sensor node of claim 8, wherein the at least one high sampling sensor includes at least one of a vibration sensor for detecting vibration of the ground surface, an acoustic sensor for detecting underground water flowing noise, and an acoustic sensor for detecting plosive sounds due to forest soil sediment disaster.

11. The sensor node of claim 8, wherein the wireless communication unit includes a low-speed communication unit configured to transmit the sensing data to a gateway through multi-hop communication in a short-range wireless network with power less than a predetermined threshold value, and a high-speed communication unit configured to transmit a large amount of the sensing information of the at least one high sampling sensor to the analysis server in real-time.

12. The sensor node of claim 11, wherein the control unit transmits the sensing data from the low sampling sensor through the low-speed communication unit, and transmits the sensing data from the high sampling sensor through the high-speed communication unit.

13. The sensor node of claim 12, further comprising:
a power adjustment unit configured to control power less than a predetermined threshold value to be applied to the low sampling sensor and the low-speed communication unit, and power larger than the predetermined threshold value to be applied to the high sampling sensor and the high-speed communication unit in accordance with the operation mode.

14. The sensor node of claim 8, wherein the control unit acquires the sensing data from the high sampling sensor and performs precision analysis to determine presence or absence of the risk to the slopes.

15. An analysis server comprising:
a communication unit;
a data analysis unit configured to analyze sensing data transmitted from at least one sensor node;
an operation mode deciding unit configured to determine presence or absence of a risk to a slope in accordance with the analysis result and decide an operation mode of the sensor node; and
an operation mode transmitting unit configured to transmit control information in accordance with the decided operation mode to the sensor node through a gateway.

16. The analysis server of claim 15, further comprising:
a database configured to store the transmitted sensing data.

17. The analysis server of claim 15, wherein the operation mode deciding unit decides the operation mode as a precision mode when a safety factor of a slope is less than a predetermined threshold value.
